(19) United States
(12) Patent Application Publication
(10) Pub. No.: US 2008/0127647 A1
(43) Pub. Date: Jun. 5, 2008

(54) Solar-Generated Steam Retrofit for Supplementing Natural-Gas Combustion at Combined Cycle Power Plants

(75) Inventor: Arnold Leitner, New York, NY (US)

Correspondence Address: GREENLEE WINNER AND SULLIVAN P C, 4875 PEARL EAST CIRCLE, SUITE 200, BOULDER, CO, 80301, US

(73) Assignee: Skyfuel, Inc., New York, NY (US)

(21) Appl. No.: 11/854,925

(22) Filed: Sep. 13, 2007

Related U.S. Application Data
(60) Provisional application No. 60/825,858, filed on Sep. 15, 2006.

(51) Int. Cl. F01K 7/16; F24J 2/04; F03G 6/00; F01K 23/00; F01K 13/00

(52) U.S. Cl. 60/645; 126/634; 60/641.8; 60/670

(57) ABSTRACT

A method is provided for retrofitting an existing combined cycle power plant to generate renewable electricity and decrease the power plant heat rate using solar energy. The method is applied to combined cycle power plants that are equipped with an oversized heat recovery steam generator (HRSG) and steam turbine system to accommodate duct burners or other means of providing additional steam to the steam turbine. The method involves retrofitting a plant with a solar energy collection system to produce solar steam for use in the steam cycle portion of the combined cycle power plant. The solar energy collection system is designed to deliver thermal energy to the existing, oversized and/or underutilized HRSG and steam system capacity in the combined cycle power plant. In addition to adding substantially to the value and usefulness of the existing combined cycle power plant, the retrofit detailed in this disclosure removes none of the functionality of the existing combined cycle power plant—it is able to operate with or without the solar energy collector system component.

### CROSS-REFERENCE TO RELATED APPLICATIONS

This application claims priority to U.S. Provisional Patent Application Ser. No. 60/825,858 filed Sep. 15, 2006, which is incorporated herein by reference to the extent not inconsistent herewith.

### BACKGROUND

High liquid or gaseous fossil fuel prices and increasing demand for electric energy require improved power plant designs to continue to provide competitively priced energy from these fuels, collectively herein referred to as “gas”. The gas-fired combined cycle power plant was designed to achieve higher efficiencies as compared to coal or oil-fired Rankine cycle plants. “Combined cycle” means that the plant uses more than one thermodynamic cycle. Combined cycle power plants and cogeneration facilities utilize gas turbines (GT(s)) as prime movers to generate power. These GT engines operate on the Brayton Cycle thermodynamic principle and typically have high exhaust flows and high exhaust temperatures. These exhaust gases, when directed into a heat recovery boiler (typically referred to as a heat recovery steam generator (HRSG)), produce steam that can be used to generate more power and/or provide process steam for industrial purposes. For additional power production the steam is directed to a steam turbine (ST), or multiple steam turbines, that utilize the steam to produce power. In this manner, the GT produces work via the Brayton Cycle, and the ST produces power via the Rankine Cycle. Thus, the name “combined cycle” is derived. In this arrangement, the GT Brayton Cycle is also sometimes referred to as the “topping cycle” and the ST Rankine Cycle is referred to as the “bottoming cycle,” as the topping cycle produces the energy needed for the bottoming cycle to operate.

Most recently many combined cycle power plants include a supplemental heating system, such as duct burners, to add additional heat to the GT exhaust by flaring gas into the HRSG. To accommodate the additional energy contributed by said duct burners, the HRSG and steam cycle system must be oversized. Combined cycle power plants operate less efficiently when duct burners are in use, but the use of said supplemental heating systems is widespread in order to generate the electricity demanded during peak use periods. Further, the supplemental heating systems in combined cycle power plants typically only operate a few hundred hours each year due to the inefficient conversion of natural gas to electricity, and emissions regulations.

There are previous attempts to integrate solar power with combined cycle power plants known to the art. However, the majority of these efforts such as those outlined in U.S. Pat. No. 5,857,322 and U.S. patent application publications 2006/0174622A1 and 2006/0260314A1 are ground-up designs rather than retrofits for a particular class of existing systems. Efforts to retrofit existing combined cycle power plants with solar energy systems have been proposed, including those described in U.S. Pat. Nos. 6,321,539, 6,237,337 and 6,694,738. However these methods use the solar energy in combination with an auxiliary gas turbine to heat compressed air that is further heated and expanded in a turbine that does not produce steam. Further efforts described in U.S. Pat. Nos. 6,000,211, 6,279,312 and 6,484,506 describe the use of solar energy for the generation of steam that is then injected into the gas turbine of the Brayton cycle component of the combined cycle power plant. This process is often referred to in the art as “steam augmentation” and is a method for generating power distinct from flowing steam through a steam turbine.

Other previously described systems known to the art, such as that described in Kelly, B. et al., “Optimization Studies for Integrated Solar Combined Cycle Systems,” Proceedings of Solar Forum 2001, Solar Energy: The Power to Choose, April 21-25, Washington, D.C., also add thermal energy to the Rankine Cycle. This concept, however, is amongst those that attempt to optimally design a solar-combined cycle hybrid system from the ground-up, and consider all of the economic issues implicit in such a design rather than designing a suitable retrofit for existing systems, or identifying existing systems suitable for retrofit. The work by Kelly, et al. is amongst a body of work associated with an effort commonly referred to in the art as “Integrated Solar Combined Cycle System” or “ISCCS.” This work includes efforts by Hosseini, Sayed, Horn, and Dersch (see References section herein).

All publications referred to herein are incorporated by reference to the extent not inconsistent herewith for purposes of meeting the written description and enablement requirements of Section 112 of the U.S. Patent Code.

### SUMMARY

A method for retrofitting existing combined cycle power plants is provided that enables the generation of additional electricity and decreases the heat rate of said combined cycle power plant using steam generated from solar radiation. The steam generated from solar radiation is generated with a solar energy collection system and conveyed to the combined cycle power plant via a heat transfer medium and utilized in the HRSG and steam turbine of the combined cycle power plant to generate additional electricity.

In the context of the present disclosure, a combined cycle power plant is a facility for generating electricity comprising: a) at least one gas turbine; b) at least one heat recovery steam generator (HRSG) sized to utilize the heat generated by the gas turbine(s) exhaust and the heat generated by a supplemental heating system; and c) at least one steam turbine approximately sized to accommodate all of the steam generated in the HRSG when the gas turbine(s) and supplemental heating system are both operating at full capacity.

An HRSG comprises, as a minimum, pipes or channels in which water is flowed to the steam turbine and means for adding heat to the water in these pipes, all as known to the art. The HRSG may also comprise duct burners or another supplemental heating system, such as an auxiliary boiler, as known to the art to add more heat to the water in the pipes. Most modern HRSGs are known to the art as “triple pressure” HRSGs and operate in three pressure regimes simultaneously, usually known to the art as “low pressure”, “intermediate pressure” and “high pressure.”

The solar energy collection system is one of many concentrating solar collectors known to the art capable of generating steam in the temperature and pressure range necessary for use in a combined cycle power plant. These include “parabolic trough”, “linear Fresnel” and “central receiver” (also known as “power tower”) technologies, as they are known to the art. In every solar energy collection system, a heat transfer medium is used to capture the heat of sun that is focused onto the “receiver” portion of the collector, as it is known to the art. In the event that the heat transfer medium is not water, the solar energy collection system may also include a heat exchanger for transferring energy from the heat transfer medium to the water in the combined cycle power plant. The solar energy collection system may also comprise one of many thermal energy storage systems known to the art such as “thermocline,” “two tank,” or pressurized water systems that will allow the energy collected in the heat transfer medium to be utilized at a time after it was captured.

The heat transfer medium can be a gas, such as air, or a liquid, such as water or oil. If the heat transfer medium is water, it can be converted to steam in the solar energy collection system and delivered directly to the steam cycle of the combined cycle power plant. If the heat transfer medium is something other than water, then a heat exchanger must be used in between the solar energy collection system and the steam cycle of the combined cycle power plant in order to exchange the heat captured in the solar energy collection system with the water used in said steam cycle.

The present process requires that the steam generated using the solar energy collection system be incorporated into the steam cycle portion of the combined cycle power plant. The integration point where the steam is incorporated into the HRSG depends on the capabilities of the solar energy collection system, the available capacity for additional steam in the steam cycle portion of the combined cycle power plant, and the proposed size of the solar system. The integration point can be somewhere in the HRSG or directly into the steam turbine. Most commonly, the solar-generated steam will be incorporated into the steam cycle portion of the combined cycle power plant in the high pressure (HP) portion of the HRSG. The HP portion of the steam cycle is best suited for integration because it results in the highest efficiency utilization of the solar energy and generally has the highest capacity for additional steam in systems designed with supplemental heating systems. In some cases, it is possible to admit steam generated in the solar energy collection system directly into the steam turbine. In the present process the solar energy collection system is connected to the steam cycle with two valves, the first allowing feed water to enter the solar energy collection system (or heat exchanger) from the steam cycle, the second valve admits steam generated in the solar energy collection system (or heat exchanger) into the HRSG or steam turbine This system of valves allows the combined cycle power plant to operate with or without solar input. With both valves fully closed, the combined cycle power plant is able to operate exactly as it did prior to retrofit.

The present process can increase the power output of the power plant by the amount that the steam cycle was oversized to accommodate the supplemental heating system. In many cases this is on the order of 15% of the capacity of the entire combined cycle power plant when the supplemental heating system is not operating. Further, integration with the combined cycle power plant can result in more efficient conversion of, as well as more annual energy generation (i.e. a higher capacity factor), from the solar energy to electricity than would be possible were the same solar energy collection system used in a “stand-alone” system.

The supplemental heating system can be operated simultaneously with or at different times from providing the solar heat. In one embodiment, said solar energy is supplied during daylight hours and the supplemental heating system, e.g., duct burners, are operated when the solar energy is not being supplied and to compensate for variations in solar input through the day. The use of supplemental heaters in conjunction with the solar energy collection system is desirable, but not essential to the present system and process.

The retrofit of a combined cycle power plant to include the use of solar-generated steam to utilize the HRSG and steam turbine capacity designed to accommodate a supplemental heating system results in a more efficient and more valuable combined cycle power plant. The use of solar energy decreases the amount of natural gas consumed to achieve a given electrical output (the “heat rate”). Further, the generation of electricity from solar energy has more value in the market as “green” energy. The ability to utilize the solar energy as it is available and in an efficient way results in an ideal hybrid facility. All of the functionality of the existing combined cycle plant is retained with the added ability of delivering “firm” electricity. The term “firm” in this context means that delivery of a specified quantity of electricity can be guaranteed to a customer. When solar energy is available, some or all of the electricity will be solar-generated electricity. When solar energy is not available, the gas turbine and/or supplemental heating system can be used to assure delivery of the required quantity of electricity.

The solar energy collection system can be added to existing combined-cycle power plants that have HRSGs and steam turbines that are not being used to their full capacity. For example, existing power plants that were designed to use supplemental heating systems to generate steam can be equipped with solar energy collection systems, or existing power plants that were built to operate at greater capacity than is economically feasible due to the cost and/or availability of fuels to run the gas turbines can be equipped with solar energy collection systems.

### DESCRIPTION OF THE DRAWING

FIG. 1 shows a schematic representation of an existing combined cycle power plant with a supplemental heating system that has been retrofitted with a solar energy collection system.

### DETAILED DESCRIPTION

A method is provided for retrofitting existing combined cycle power plants to improve the performance of said combined cycle power plants by improving their heat rate and adding value through the generation of additional electricity using steam generated with a solar energy collection system and delivered to the HRSG or steam turbine portion of the combined cycle power plant. In contrast to previous retrofitting systems, the present system adds heat to the Rankine cycle component of an existing combined cycle power plant. The retrofitted combined cycle power plant is described below. A combined cycle power plant comprising a solar energy collection system can also be built from the ground up in accordance with the description herein.

A system for generating power is provided, said system comprising: a) at least one gas turbine that generates heated exhaust gas; (b) at least one heat recovery steam generator (HRSG) for generating steam from said heated exhaust gas, said HRSG comprising a supplemental heating system, and being operatively connected to the gas turbine(s); (c) a steam turbine operatively connected to the HRSG wherein said steam turbine has a capacity at least sufficient to utilize all of the steam generated in the HRSG when the gas turbines and the supplemental heating system are operating at full capacity; (d) a solar energy collection system operatively connected to the HRSG or the steam turbine for capturing solar radiation for heating a heat transfer medium, thereby generating solar steam; and (e) means for conveying the solar steam to the HRSG for operation of the steam turbine. In many embodiments, the system comprises at least two gas turbines.

In an embodiment, the gas turbine, HRSG, supplemental heating system, and steam turbine are comprised within a pre-existing combined cycle power plant, and the solar energy collection system is an additional component that has been retrofitted thereto.

The supplemental heating system can comprise duct burners that burn natural gas to produce additional heat for heating exhaust gases from the gas turbine. The supplemental heating system can also comprise auxiliary fossil-fired boilers, such as gas-, oil- or coal-fired boilers.

The heat transfer medium used in the solar collection system can be water, air, oil-based heat transfer fluids, or molten salt or a mixture of molten salts, all as known to the art or hereafter discovered. When the heat transfer medium is water, it can be directly converted to solar steam in the solar collection system, and the solar steam can be introduced into the HRSG or steam turbine. When the heat transfer medium is another medium, it can be cycled through a heat exchanger to heat steam that flows into the solar collection system from the HRSG or directly from a steam condenser upstream from the HRSG of the combined cycle power plant. The term “solar steam” is used both for steam generated by converting water used as a heat transfer medium in the solar collection system to steam, and for steam generated indirectly from water coming into the solar collection system from outside using heat from a heat transfer medium used in the solar collection system that is not water.

The system can also comprise a storage device for storing thermal energy captured in the heat transfer medium of the solar collection system. This storage device can use one or two large, well-insulated tanks to store the heat transfer medium after it has absorbed the solar energy, or other means known to the art, such as pressurized water storage devices. In some cases the storage system uses the same heat transfer medium used in the solar concentrator system to store thermal energy; in others a secondary storage medium is employed. For example, the solar concentrator system can use an oil-based heat transfer fluid and molten salt can be used as the secondary storage medium. The storage system is part of the solar energy collection system, whereby the heat transfer medium, or secondary storage medium, is reserved for use later to generate steam for delivery to the HRSG or steam turbine. Heat can be stored in the storage device for use at times when the sun does not shine or to shift the use of peak solar output to a time past the natural solar peak.

The solar energy collection system can comprise a parabolic trough system, a linear Fresnel reflector system, a central receiver system or other line-focus or point-focus solar collection components known to the art. A central receiver system is a solar concentrator system that focuses solar energy using a large field of mirrors onto a single point, the “power tower.” Central receiver systems are able to generate higher temperatures more efficiently than the parabolic trough or linear Fresnel line-focus geometries. A linear Fresnel reflector system, as known to the art, uses rows of long reflectors to focus light onto a linear receiver. Line-focus solar collection systems, including linear Fresnel reflector systems and parabolic trough systems, are any solar collection system that uses reflective or refractive optical devices to focus light onto a line. Point-focus solar collection systems, including the central receiver systems, are any solar collection systems that use reflective or refractive optical devices to focus light onto a single point, or area. In an embodiment, the solar energy collection system comprises a parabolic trough system.

The steam turbine is oversized relative to the capacity needed to accommodate steam produced by waste heat from the gas turbine(s) alone. The oversized steam turbine has a size between about 15% and about 50% greater than the size required to accommodate steam produced in the HRSG only by heat from exhaust gas from the gas turbine(s). It typically has a size sufficient to accommodate both exhaust gas from the gas turbine(s) when running at full capacity, and the supplemental heating system when running at full capacity. In embodiments, it may have a greater size, that is, a size sufficient to accommodate the heat from the gas turbine(s), the supplemental heating system, and the solar collection system, all running at the same time at full capacity.

In many existing combined cycle power plants with supplemental heating systems, the steam turbine has a size typically up to about 50% greater than the size required to accommodate the steam produced in the HRSG only by heat from exhaust gas from the gas turbine(s) when it/they are running at full load. The solar energy collection system can be sized to deliver sufficient steam to utilize part or all of the excess capacity of the steam turbine when the supplemental heating system is not operating, or when the gas turbines are operating only at part capacity. If the steam turbine provides more capacity than needed to accommodate the steam supplied by the gas turbine(s) and supplemental heating system when both are running at full capacity, the solar energy collection can be sized to deliver sufficient steam to utilize all this excess capacity.

The system also includes valves for controlling the flow of water and steam from the combined cycle power plant to and from the solar energy collection system. The valves can be operated manually, or can be operated automatically by means of switches controlled by processors programmed to turn off and on the connection between the components or to control the flow from one component to another. The control of the system can be designed to allow maximum input to the HRSG or steam generator from the solar collection system during times when the sun is shining, and to supplement or replace the input to the steam generator from the solar collection system with input from the gas turbine(s) and/or supplemental heating system when the sun is not shining.

Also provided herein is a method for retrofitting an existing combined cycle power plant that generates electricity to utilize solar steam generated from the heat of collected solar radiation, wherein the combined cycle power plant comprises: a) at least one gas turbine that generates exhaust gas; b) at least one heat recovery steam generator (HRSG) comprising a supplemental heating system for heating steam produced in the HRSG by heat from said exhaust gas and optionally from said supplemental heating system; c) at least one steam turbine having a size at least sufficient to accommodate all of the steam produced in the HRSG when the gas turbine(s) and supplemental heating system are operating at full capacity. The method for retrofitting comprises: (a) providing a solar energy collection system that captures heat from solar radiation in a heat transfer medium and generates solar steam from the captured heat; and (b) connecting said solar energy collection system to said HRSG or said steam turbine, whereby solar steam provides some or all the steam required for operation of said steam turbine.

The solar steam can be routed directly to a duct entering the steam turbine, or can be routed into a steam line in the HRSG.

Also provided herein is a method for increasing the power output of a combined cycle power plant. The method comprises: (a) connecting a solar energy collection system to a combined cycle power plant having (i) at least one gas turbine, and (ii) at least one HRSG comprising a supplemental heating system, and (iii) a steam turbine; (b) activating the solar energy collection system to produce solar steam; and (c) introducing said solar steam directly or indirectly into the steam turbine; whereby the solar steam increases the power output of said power plant beyond the output of the power plant when the gas turbine(s) are operating at full capacity and the supplemental heating system is not operating.

The supplemental heating system and the solar collection system can be operated simultaneously, or one of them can be turned off when the other is operating. For example, the solar collection system can be operated only when the sun is shining during daylight hours, and the supplemental heating system can be operated only at night or when it is cloudy. In addition, the contributions from the solar collection system and supplemental heating system can be adjusted to accommodate peak demands on the system. For example, both can be operated at once, or solar steam can be introduced to the system from a storage device for solar heat that is part of the solar collection system.

The connection between the combined cycle power plant and the solar energy collection system can be turned “off” or “on” as desired. When it is turned off, a retrofitted plant can operate as it would have prior to the retrofit. In an embodiment, retrofitting is performed without changing the size and position of major existing HRSG and steam system components, wherein major existing components include feedwater pumps, steam turbines, condensers, and heat exchangers.

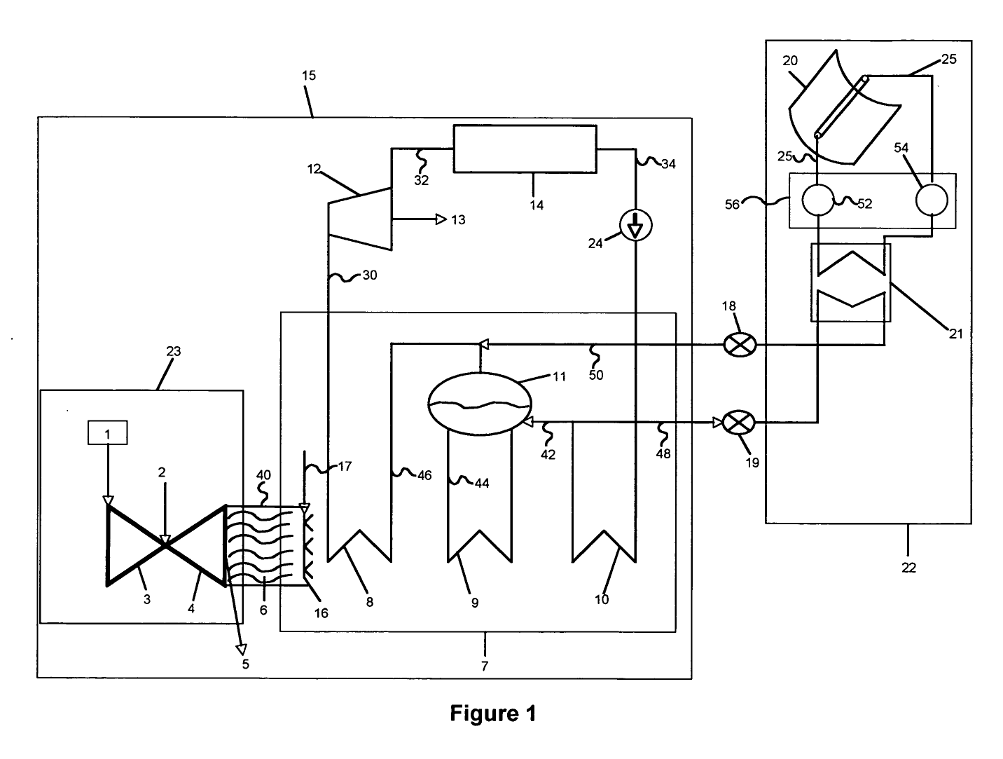

Modern heat recovery steam generators (HRSG) typically comprise three separate steam flows at three distinct pressures. These pressures are commonly referred to in the art as low pressure (LP), intermediate pressure (IP) and high pressure (HP). Steam generated with solar energy in the solar energy collection system (referred to as “solar steam” herein) can be provided at conditions for incorporation into any of the LP, IP or HP steam flows. However, in an embodiment hereof shown in FIG. 1, the steam generated using the solar energy collection system is integrated into the HP steam flow in the HRSG because this results in the most efficient use of the collected solar radiation. To facilitate implementation and understanding of the present system, FIG. 1 shows only a single steam flow through the HRSG. This steam flow can be taken to be the HP steam flow.

The schematic drawing of FIG. 1 is simplified for interpretation—it shows a single gas turbine, a single HRSG and a single steam turbine with only one flow of steam to that steam turbine (this is known as a “1×1×1” in the art). In most modern combined cycle power plants there are more than one gas turbine, more than one HRSG and multiple flows of steam to the steam turbine. Modern combined cycle power plants also typically use “reheat,” a method known to the art for improving plant efficiency. Reheat involves the extraction of some steam from the steam turbine, the “reheating” of that steam in the HRSG, then the re-injection of the reheated steam back into the steam turbine. This increases plant efficiency by better utilizing the energy available in the exhaust from the gas turbine. Plants also use many heat exchanger stages that are ordered such that performance is maximized. These typical features have been omitted from FIG. 1. A common combined cycle configuration is “2×2×1” wherein there are two gas turbines, two HRSGs and one steam turbine. FIG. 1 can be considered as either a “1×1×1” configuration or as one-half of a “2×2×1” configuration. Embodiments of the present system and process involve all combinations of gas turbines, HRSGs and steam turbines.

Referring to FIG. 1, a combined cycle power plant 15 comprises at least one gas turbine system 23 connected via exhaust gas conduit 40 to at least one heat recovery steam generator (HRSG) 7 that generates steam. The HRSG is connected via steam line 30 to steam turbine 12, which outputs power via steam power output line 13. The combined cycle power plant 15 also comprises condenser 14 connected via steam exhaust conduit 32 to steam turbine 12 for condensing the exhaust of steam turbine 12 so that it can be returned via water line 34 through pump 24 to the HRSG 7, and used again for the generation of steam.

The “solar steam” is steam that is directly or indirectly provided by the solar energy collection system 22, i.e., steam generated by the solar energy collection system that flows through the steam system, typically as vapor, with a specific enthalpy higher than the specific enthalpy of the working fluid returning from the condenser, or other cold sink of the steam turbine Rankine cycle.

“Rankine steam system” refers to the steam Rankine cycle portion of the combined cycle power plant including, the HRSG 7, steam turbine and generator 12, condenser 14 and feed water pump 24.

Each gas turbine system 23 comprises a compressor 3 operably connected to gas turbine 4. Air is injected into compressor 3 through air injector 1. Natural gas fuel is also introduced into compressor 3 via natural gas fuel line 2 where it is combusted with the air. The hot air-gas mixture formed in compressor 3 is then expanded in adjoining, operably connected, gas turbine 4 whereby gas-generated power is output from gas power output line 5 is generated and hot exhaust gases 6 are released and conveyed via exhaust gas conduct 40 to HRSG 7.

HRSG 7 has multiple stages of heat exchangers: a preheater 10 connected via water line 34 to condenser 14, where the condensed water returned from condenser 14 is raised to a temperature near boiling at the pressure of the flow. The heated water is then conducted via hot water line 42 to evaporator 9 where some of it is vaporized. The mixed steam and water is then conducted via steam/water line 44 to steam drum 11 where the steam is separated from the liquid portion. Steam drum 11 is connected via separated steam line 46 to superheater 8 where the steam is superheated and sent via steam line 30 for expansion in steam turbine 12, which generates power exiting the combined cycle power plant 15 via steam power output line 13.

The HRSG 7 also comprises a supplemental heating system, shown in FIG. 1 as duct burners 16 fed with fuel such as natural gas via duct burner fuel line 17. The supplemental heating system is a means for contributing additional thermal energy to the HRSG 7 in order to increase steam delivery to the steam turbine 12. In an embodiment, the duct burners 16 operate by burning natural gas in the HRSG to increase the energy contained within the hot gases 6 from the gas turbine 4. The preheater 10, evaporator 9, steam drum 11, superheater 8, steam turbine 12, condenser 14, and pump 24 are all sized to accommodate the steam generated when both the gas turbine system 23 and the duct burners (supplemental heating system) 16 are operating at full capacity.

The steam turbine 12, condenser 14 and feed water pump 24 constitute means for producing power from steam having an elevated temperature and pressure and are known to the art.

In the present system, we utilize the capacity of the steam generator 12 in excess of that which is necessary for accommodating the hot exhaust gas 6 from gas turbine system 23 alone, along with the steam generated by the solar energy collection system 22, to increase the power output of the plant.

The HRSG 7 of combined cycle power plant 15 is connected to solar energy collection system 22 via hot water exit line 48 connected to hot water line 42, through which some of the water coming from preheater 10 is withdrawn on its way to steam drum 11. Hot water exit line 48 is equipped with hot water exit valve 19 through which water flows through heat exchanger 21 of solar energy collection system 22 where it receives heat from the heat transfer medium contained in heat transfer medium conduit 25 that is operably connected to heat exchanger 21, whereby the water is converted to steam. Heat exchanger 21 is connected via heat transfer medium conduit 25 to solar concentrator system 20. Heat transfer medium conduit 25 exiting solar concentrator system 20 is typically connected to pumps (not shown) for circulating a heat transfer medium through the solar collection system 22, as well as booster pumps (not shown) to ensure that a significant pressure drop does not develop in the heat transfer medium conduit 25. In an embodiment, the heat transfer medium is a fluid that circulates in the solar collection system 22 as a single phase fluid, such as Therminol VP-1 (an oil-based fluid), molten-salts or other heat transfer media known to the art. It is also possible to use water as the heat transfer medium.

The solar collection system 22 can comprise any solar concentrator system 20 known to the art, such as a parabolic trough system, a linear Fresnel system, or a central receiver system. In an embodiment, the solar concentrator system 20 comprises a parabolic trough concentrator. The temperature of the heat transfer medium is increased as energy is transferred to it in the form of solar radiation in solar concentrator system 20. After reaching a sufficiently high temperature, the heat transfer medium is delivered via heat transfer medium conduit 25 to heat exchanger 21 where heat is transferred from it to the hot water in hot water exit line 48 entering solar collection system 22. This hot water is turned to solar steam and conveyed by means of solar steam conduit 50 through solar steam valve 18 to separated steam line 46 exiting steam drum 11 of HRSG 7.

In heat exchanger 21, energy is transferred from the heat transfer medium to water drawn via hot water exit line 48 from hot water line 42 of the HRSG 7. Energy is transferred to the hot water such that it vaporizes and becomes steam of a sufficient temperature, e.g., about 330° C. to about 400° C., for the embodiment shown in FIG. 1. In an embodiment, steam is produced having a temperature of about 370° C. The pressure of the steam produced by energy transfer in preheater 21 is typically at a pressure between about 100 bar to about 130 bar in the embodiment shown in FIG. 1. In an embodiment, this pressure is about 125 bar. These temperature and pressure conditions are chosen to allow for efficient integration of the steam into a HP steam flow of the HRSG 7. In the case in which water is used as the heat transfer medium, heat exchanger 21 becomes unnecessary, as water drawn from the HRSG 7 of the combined cycle power plant 15 can be made into steam of sufficient temperature and pressure through the addition of energy by means of solar radiation in the solar energy collection system 22. The steam generated in the solar energy collection system 22 can then be directly and efficiently incorporated back into the steam flow of the HRSG 7 via solar steam conduit 50 through solar steam valve 18.

The solar collection system 22 can also feature a thermal energy storage system 56. There are many embodiments of thermal energy storage systems; any such system known to the art can be used, such as “two tank” systems, single tank systems (also known as “thermocline”), and pressurized water storage systems. In an embodiment, the storage system is a “two tank” storage system whereby the heat transfer medium is stockpiled in a “hot” storage tank 54 after it has absorbed thermal energy in the solar concentrator system 20. The second tank of the “two tank” system, “cold” storage tank 52, is used to stockpile the stored fluid as it is pumped out of the “hot” storage tank 54 and through the heat exchanger 21. The thermal energy storage system allows the thermal energy that is captured by the solar collection system 22 to be stored so that steam can be delivered to the HRSG 7 or steam turbine 12 of the combined cycle power plant 15 at a time after that energy was collected by the solar collection system.

The combined cycle power plant 15 is retrofitted in the present system and process by interconnecting it with the solar energy collection system 22 by means of two valves: solar steam valve 18 and hot water exit valve 19, or by other means known to the art. As shown in FIG. 1, water from the HRSG 7 of the combined cycle power plant 15 is admitted to the solar energy collection system 22 by means of valve 19. Water from the HRSG 7 can be extracted from numerous locations and at any of the typical HRSG 7 operating pressures (LP, IP, and HP); but in the embodiment shown, it is withdrawn from the flow of water flowing from HP preheater 10 to HP steam drum 11. The water then flows into solar energy collection system 22 wherein it receives additional energy and is converted into steam of sufficient temperature and pressure for re-integration into the HRSG. In an embodiment where steam is re-introduced to the HRSG steam flow downstream from the HP steam drum 11, the steam coming from solar energy collection system 22 must be at least saturated at the pressure in the HP steam drum, and preferably is superheated. For typical combined cycle power plant operating conditions, an embodiment would requires steam temperatures above about 330° C. and pressures above about 100 bar for integration into the HP steam flow of the HRSG 7. After the water has been admitted to the solar energy collection system 22 through hot water exit valve 19 and converted to steam, it is re-admitted to the HP steam flow of HRSG 7 through solar steam valve 18.

There are many possible integration points for the steam passing through solar steam valve 18, wherein the steam from the solar energy collection system 22 is re-integrated into the same steam flow (i.e., LP, IP or HP) that the water for solar steam generation was extracted from. In an embodiment the steam is incorporated to the HP steam flow of HRSG 7 between the steam drum 11 and the superheater 8. Integrating the flow of solar steam through valve 18 before the superheater 8 stage of the HRSG 7, the solar steam receives additional heating from the exhaust gases 6 from gas turbine system 23 and duct burners 16. In this way, the conversion of solar energy to electricity is of a higher efficiency than that typically seen in “stand-alone” solar power plants. The specific integration point is typically determined based on the temperatures achievable by solar energy collection system 22 and constraints of the HRSG 7 design. That is, thermodynamically and practically, it is preferred to integrate the steam generated by solar energy at a point where the temperature of the solar-generated steam is close to the temperature of the steam flow in the HRSG 7. This results in less destruction of thermodynamic availability, and minimizes large piping temperature gradients, which can create large stresses. The design of HRSG 7 will further determine the integration location based on the accessibility of different parts of the HRSG 7, as it is important for cost reasons to minimize the invasiveness of the retrofit. In an embodiment, the feedwater is extracted downstream from preheater 10 and reintroduced downstream from steam drum 11 because these represent points in the HRSG 7 that are readily accessible for retrofit, minimize temperature differences between steam flows and result in efficient utilization of the solar energy. In some embodiments, it would be possible to admit the steam generated in the solar energy collection system 22 directly into steam turbine 12, without passing through the any parts of the HRSG 7. It is possible to introduce steam directly into the steam turbine when the solar energy collection system 22 can produce steam in the range of temperatures and pressures that the steam turbine is designed to accept, or when the temperature and pressure of a mixed flow of steam generated in the solar energy collection system 22 and in the HRSG 7, combined just upstream of the inlet of the steam turbine, are within the design constraints of the steam turbine.

The retrofitting method described herein relies on the capacities and limitations of the existing HRSG and Rankine steam system equipment. Using the capacity designed into the HRSG and the remainder of the Rankine cycle steam system enables the retrofit described herein to require minimal modification to the existing hardware of the HRSG. It is typically the size of the supplemental heating system (which typically includes duct burners) that determines the amount of steam that can be delivered by the solar energy collection system at any given time provided the gas turbine system is operating at full capacity. In some embodiments it may be desirable to operate the gas turbine system of the combined cycle power plant at a reduced load in order to enable the utilization of a larger amount of solar steam generated by the solar energy collection system. In many modern combined cycle power plants the supplemental heating system is designed to provide up to about 15% of additional output to the facility. Increasing plant output by 15% typically corresponds to an approximately 50% oversizing of the steam capacity of HRSG 7, steam turbine 12, condenser 14 and feed water pump 24. Thus in a 525 MWₑ combined cycle power plant there is typically up to about 80 MWₑ of supplemental capacity that can be potentially utilized by the present solar energy retrofitting system.

One embodiment, depicted in FIG. 1, integrates the solar energy collection system 22 with an HRSG 7 that separates the steam and water in a steam drum 11. However, some HRSGs use a “once-through” evaporator 9 wherein the steam drum 11 is not present. Such HRSGs are also suitable for retrofit as described herein.

The solar energy retrofit system is designed and operated such that the combined cycle power plant requires minimal modification and operates within its design constraints and limitations such that if the solar energy collection system were removed it could operate exactly as it did prior to the retrofit.

Many control strategies known to the art are possible for the solar collection system. In an embodiment, the solar collection system is controlled such that it delivers the heat transfer medium at constant temperature conditions. Thus, in this embodiment the solar collection system would begin collecting solar energy as the sun rises, re-circulating the heat transfer medium to increase its temperature. As more solar radiation is collected the temperature of the heat transfer medium increases. As the temperature of the heat transfer medium reaches the design temperature, about 400° C. in an embodiment, water from the HRSG 7 is admitted to the heat exchanger 21 through hot water exit valve 19. The design temperature is determined based on the safe operating range of the chosen heat transfer medium and the temperature required for efficient operation of the solar energy collection system 22. The on-off position of the hot water exit valve 19 would vary as the thermal energy being delivered to the heat exchanger 21 from the solar collection system 22 varied. In this way, steam of consistent temperature and pressure, measured downstream from steam valve 18, by means known to the art, would be integrated into the HP steam flow of HRSG 7 through solar steam valve 18. This embodiment minimizes thermal transients in the HRSG piping system and results in consistent, predictable performance of the HRSG and steam turbine. In such instances where there is more solar radiation available than can be utilized or stored, the solar collection system controls will defocus some of the collectors to limit energy collection and prevent overheating of the heat transfer medium.

The solar energy collection system 22 typically operates at part load during the majority of the year as it is only during the noon hours of the peak summer months where it approaches its maximum output. In various embodiments, the supplemental heating system 16 can operate at full- or part-load to supply additional energy to HRSG 7 when solar energy collection system 22 is operating at full- or part-load in order to supplement the solar input and utilize all of the available steam system capacity. Alternatively, when solar energy collection system 22 is operating at full- or part-load it can deliver steam to the HRSG without any additional energy being contributed by the supplemental heating system.

The solar steam valve 18 and hot water exit valve 19 that connect that combined cycle power plant 15 to the solar energy collection system 22 are controlled to ensure the safe operation of HRSG 7. In the event that the water levels in steam drum 11 become too high or too low, as determined by the instrumentation and control systems, as known to the art, installed in all HRSG systems, water flow through valve 19 can be increased or decreased in order to aid in the regulation of safe HRSG operations.

At any time, whether for operational or safety reasons, the solar energy collection system 22 can be valved off and effectively disconnected from the combined cycle power plant. When valves 18 and 19 are closed the combined cycle power plant is able to operate exactly as it did prior to the retrofit as no physical changes to the steam system piping were made that would affect the thermal performance of HRSG 7.

The solar energy collection system 22 can further comprise an automated control system including a computer processor (not shown) programmed with an algorithm for operating solar steam valve 18 and hot water exit valve 19, and controlling the position of the collectors and controlling the flow of the heat transfer medium through the solar energy collection system. The control systems of the combined cycle power plant 15 and solar energy collection system 22 can be linked together such that each system responds appropriately to events occurring in the others. Most importantly, the valves 18 and 19 are controlled to ensure the HRSG control system (in place prior to the retrofit) can regulate the steam drum 11 water levels.

In embodiments where a thermal energy storage device is employed, the thermal energy storage device can be used when thermal energy captured by the solar concentrator system 20 is needed to supplement the energy produced in the remainder of combined cycle power plant 15. The time at which power is generated from the energy delivered by the solar energy collection system 22 can be controlled using thermal energy storage device 56. The operation of a thermal energy storage device is dictated by the economic and operational requirements of a specific installation and the value the solar energy creates when it is delivered. The value of the energy is typically determined by standard utility rate structures or the terms of a power purchase agreement (“PPA”). In an embodiment, the storage system is sized and operated to maximize the delivery of steam from the solar energy collection system during the periods when said steam had the highest value.

Although certain embodiments have been principally discussed herein, it is to be understood that minor variations may be made in the retrofit of a specific combined cycle power plant without departing from the spirit and scope of the present system and process, as defined in the claims.

### REFERENCES

### US Patent Documents

2006/0174622A1 08/2006, Skowronski
2006/0260314A1
U.S. Pat. No. 5,857,322
U.S. Pat. No. 5,899,199 08/2006, Skowronski
U.S. Pat. No. 6,000,211 12/1999, Bellac et al
U.S. Pat. No. 6,131,565 11/2006, Kincaid & Skowronski
U.S. Pat. No. 6,237,337 05/2001, Bronicki et al
U.S. Pat. No. 6,279,312
U.S. Pat. No. 6,321,539 11/2002, Bronicki et al
U.S. Pat. No. 6,484,506 11/2002, Bellac et al
U.S. Pat. No. 6,694,738 02/2004, Bronicki et al
U.S. Pat. No. 6,694,738 08/2001, Hennecke
U.S. Pat. No. 6,792,759 09/2004, Rollins, III

### International Patent Documents

WO05003645
WO05003646
WO05003647
WO05078360

### Other Documents

Dersch, J., et al., “Trough integration into power plants—a study on the performance and economy of integrated solar combined cycle systems,” Energy 29 (2004) pp. 947-959
El-Sayed, M., “Solar supported steam production for power generation in Egypt,” Energy Policy 33 (2005) pp. 1251-1259
El-Wakil, M. M., “Powerplant Technology,” New York: McGraw-Hill Hardcover, 1984, pp. 341-351.
Horn, M., et al., “Economic analysis of integrated solar combined cycle power plants; A sample case: The economic feasibility of an ISCCS power plant in Egypt,” Energy 29 (2004) pp. 935-945
Hosseini, et. Al., “Technical and economic assessment of the integrated solar combined cycle power plants in Iran,” Renewable Energy 30 (2005) pp. 1531-1555
Kelly, B. et al., “Optimization Studies for Integrated Solar Combined Cycle Systems,” Proceedings of Solar Forum 2001, Solar Energy: The Power to Choose, April 21-25, Washington, D.C.

1. A system for generating power comprising:
(a) at least one gas turbine that generates heated exhaust gas;
(b) at least one heat recovery steam generator (HRSG) for generating steam from said heated exhaust gas, said HRSG comprising a supplemental heating system and being operatively connected to the gas turbine(s);
(c) a steam turbine operatively connected to the HRSG wherein said steam turbine has a capacity at least sufficient to utilize all of the steam generated in the HRSG when the gas turbines and the supplemental heating system are operating at full capacity;
(d) a solar energy collection system operatively connected to the HRSG or the steam turbine for capturing solar radiation for heating a heat transfer medium, thereby generating solar steam; and
(e) means for conveying the solar steam to the HRSG for operation of the steam turbine.

2. The system of claim 1 comprising at least two gas turbines.

3. The system of claim 1 also comprising a storage device for storing thermal energy captured in said heat transfer medium.

4. The system of claim 1 wherein said solar energy collection system also comprises a thermal energy storage system.

5. The system of claim 1 wherein said supplemental heating system comprises duct burners.

6. The system of claim 1 wherein said supplemental heating system comprises an auxiliary fossil-fired boiler.

7. The system of claim 1 wherein said heat transfer medium is selected from the group consisting of water, air, oil-based heat transfer fluids, and molten salt or mixtures of molten salts.

8. The system of claim 1 wherein the solar energy collection system comprises a parabolic trough system.

9. The system of claim 1 wherein the solar collection system comprises a linear Fresnel reflector system.

10. The system of claim 1 wherein the solar energy collection system comprises a central receiver.

11. The system of claim 1 wherein the solar energy collection system comprises a line-focus solar collection system.

12. The system of claim 1 wherein the solar energy collection system comprises a point-focus solar collection system.

13. The system of claim 1 wherein the solar energy collection system comprises a heat exchanger for generating steam using said heat transfer medium.

14. The system of claim 1 wherein the connection between the solar energy collection system and the combined cycle power plant comprises means for regulating, or eliminating completely, the amount of solar generated steam delivered by the solar energy collection system.

15. The system of claim 1 wherein said steam turbine has a size at least about 15% to 50% greater than the size required to accommodate steam produced in the HRSG only by heat from exhaust gas from the gas turbine(s).

16. The system of claim 1 wherein said solar energy collection system is sized to deliver sufficient steam to utilize part or all of the HRSG and steam turbine capacity of the combined cycle power plant available when the gas turbine(s) are operating at full load but the supplemental heating system is not operating.

17. A method for retrofitting an existing combined cycle power plant that generates electricity so that it utilizes solar steam generated from the heat of collected solar radiation, said combined cycle power plant comprising: a) at least one gas turbine that generates exhaust gas; b) at least one heat recovery steam generator (HRSG) comprising a supplemental heating system; c) at least one steam turbine having a size at least sufficient to accommodate all of the steam produced in the HRSG when the gas turbine(s) and supplemental heating system are operating at full capacity; said method for retrofitting comprising:
(a) providing a solar energy collection system that captures heat from solar radiation in a heat transfer medium and generates solar steam from said captured heat; and
(b) introducing said solar steam into said HRSG, such that said solar steam provides some or all the steam required for operation of said steam turbine.

18. The method of claim 17 wherein said heat transfer medium is selected from the group consisting of water, air, oil-based heat transfer fluids, and molten salt or mixtures of molten salts.

19. The method of claim 17 wherein the solar energy collection system comprises a parabolic trough system.

20. The method of claim 17 wherein the solar collection system comprises a linear Fresnel reflector system.

21. The method of claim 17 wherein the solar energy collection system comprises a central receiver.

22. The method of claim 17 wherein the solar energy collection system comprises a line-focus solar collection system.

23. The method of claim 17 wherein the solar energy collection system comprises a point-focus solar collection system.

24. The method of claim 17 comprising connecting a duct for routing solar steam directly to a duct entering the steam turbine.

25. The method of claim 17 comprising connecting a duct for routing solar steam to a steam line in the HRSG that is upstream from at least one stage of superheating in the HRSG.

26. The method of claim 17 wherein the solar energy collection system comprises a heat exchanger in which solar steam is generated using the heat from the heat transfer medium.

27. The method of claim 17 wherein the solar energy collection system is sized to deliver sufficient steam to utilize part or all of the HRSG and steam turbine capacity available when the gas turbines are operating at full load and the supplemental heating system is not operating.

28. The method of claim 17 wherein the retrofit of the combined cycle power plant is carried out without changing the size and position of major existing HRSG components.

29. A method for increasing the power output of a combined cycle power plant, said method comprising:
(a) connecting a solar energy collection system to a combined cycle power plant having an (i) at least one gas turbine, and (ii) an HRSG designed to accommodate heat generated by the gas turbine(s) and a supplemental heating system, and (iii) a steam turbine designed to accommodate the steam generated by the HRSG when the gas turbines and supplemental heating system are both operating at full capacity.
(b) activating said solar energy collection system to produce solar steam; and
(c) introducing said solar steam directly or indirectly into said steam turbine;
whereby said solar steam increases the output of said combined cycle power plant beyond the output it would achieve under normal full-load operation, normal full-load operation being when i) the gas turbine(s) are operating at full-load and ii) the supplemental heating system is not operating.

30. The method of claim 29 comprising operating the supplemental heating system and the solar energy collection system simultaneously.

31. The method of claim 29 comprising operating the supplemental heating system and solar energy collection system at different times.
